(19) United States
(12) Patent Application Publication
(10) Pub. No.: US 2015/0185730 A1
(43) Pub. Date: Jul. 2, 2015

(54) MULTI-PROCESS AUTOMATIC MACHINE SYSTEM

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: WEN-JIE LONG, Shenzhen (CN); BO XIAO, Shenzhen (CN); FENG ZHANG, Shenzhen (CN); AI-JUN TANG, Shenzhen (CN); WEI-HUA LIU, Shenzhen (CN)

(21) Appl. No.: 14/582,688

(22) Filed: Dec. 24, 2014

(30) Foreign Application Priority Data
Dec. 31, 2013 (CN) 201310748049.0

(51) Int. Cl. G05B 19/418; B25J 9/00

(52) U.S. Cl. CPC G05B 19/4189; B25J 9/0084; B25J 9/0096; Y10S 901/46; G05B 2219/39157

(57) ABSTRACT

A multi-process automatic machine system is configured to machine different surfaces of a workpiece. The multi-process automatic machine system includes at least two first robots, at least two first machining devices, and at least one transfer table positioned between the at least two first robots. Each first machining device is positioned adjacent to one of the at least two first robots. One of the at least two first robots is configured to translationally move the workpiece to the at least one transfer table after the first machining surface being machined. The at least one transfer table is configured to rotate the workpiece. Another one of the at least two first robots is configured to translationally move the workpiece from the at least one transfer table to the corresponding one of the at least two first machining device.

### FIELD

The subject matter herein generally relates to multi-process automatic machine systems, and particularly to a multi-process automatic machine system having robots and transfer tables.

### BACKGROUND

A workpiece can be machined in many processes, such as polishing, marking, cutting, and so on. In a multi-process automatic machine system, robots can be used to improve efficiency.

### BRIEF DESCRIPTION OF THE DRAWINGS

Implementations of the present technology will now be described, by way of example only, with reference to the attached figures.

FIG. 1 is a diagrammatic view of an embodiment of a multi-process automatic machine system configured to machine a workpiece.

FIG. 2 is a top view of an embodiment of a workpiece.

FIG. 3 is a bottom view of the workpiece of FIG. 2.

FIG. 4 is a first oblique view of the workpiece of FIG. 2.

FIG. 5 is a second oblique view of the workpiece of FIG. 2.

FIG. 6 is a cross-sectional view along a line VI-VI of the workpiece of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is in relation to a multi-process automatic machine system configured to machine different surfaces of a workpiece. The multi-process automatic machine system can include at least two first robots, at least two first machining devices, and at least one transfer table positioned between the at least two first robots. Each first machining device can be positioned adjacent to one of the at least two first robots. One of the at least two first machining devices can be configured to machine a first machining surface of the workpiece and another one of the at least two first machining devices can be configured to machine a second machining surface of the workpiece. One of the at least two first robots can be configured to translationally move the workpiece to the at least one transfer table after the first machining surface being machined. The at least one transfer table can be configured to rotate the workpiece. Another one of the at least two first robots can be configured to translationally move the workpiece from the at least one transfer table to the corresponding one of the at least two first machining device, for machining the second machining surface.

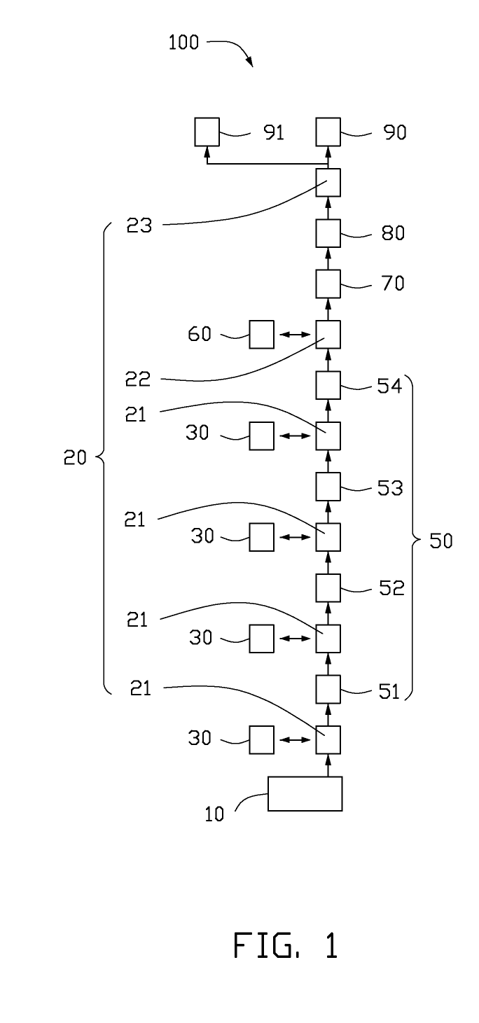

FIG. 1 illustrates an embodiment of a multi-process automatic machine system 100 which can include a tray transfer device 10, at least two robots 20, at least two first machining devices 30, and at least one transfer table 50. The tray transfer device 10 can be configured to support a plurality of trays (not shown) for receiving workpieces. The plurality of trays can be stacked on the tray transfer device 10. When a tray at a top of the stacked trays is removed, the left trays can be raised a height of a thickness of the tray by the tray transfer device 10. Thus, the tray at a top of the stacked trays can be kept in a same height. The at least two robots 20 can be located at a side of the tray transfer device 10 and configured to hold the workpieces. The at least two first machining devices 30 can be located opposite to the at least two robots 20, respectively. Each first machining device 30 can be positioned at a side of the corresponding robot 20. The at least one transfer table 50 can be located between the at least two robots 20 and configured to position and transfer the workpieces.

In the illustrated embodiment, the at least two robot 20 can include four first robots 21, a second robot 22, and a third robot 23. The first robots 21, the second robot 22, and the third robot 23 can be arranged in sequence and in a substantially straight line. The tray transfer device 10 can be located at an end of the first robots 21 and adjacent to one of the first robots 21. The second robot 22 can be located at a side of the first robots 21 away from the tray transfer device 10. The third robot 23 can be located at a side of the second robot 22 away from the first robots 21.

A number of the first machining device 30 can be four. The first machining devices 30 can be arranged in a substantially straight line parallel to the first robots 21. Each first machining device 30 can be positioned at a side of each first robot 21 and opposite to the first robot 21. In the illustrated embodiment, the first machining devices 30 can be riveting devices.

The transfer table 50 can position a workpiece and rotate the workpiece. Thus, it is convenient for the first machining device 30 to machine different places of the workpiece. In the illustrated embodiment, a number of the transfer table 50 can be four. The four transfer tables 50 can be a first transfer table 51, a second transfer table 52, a third transfer table 53, and a fourth transfer table 54. Each of the first transfer table 51, the second transfer table 52, and the third transfer table 53 can be positioned between two adjacent first robots 21. The fourth transfer table 54 can be positioned between the second robot 22 and the adjacent first robot 21. The four transfer tables 50 and the six robots 20 can be arranged in a substantially straight line. The transfer tables 50 can include a rotation structure in a well known technology, such as a flipping mechanism. For in sake of simplify, a description of the structure of the transfer table 50 is omitted.

In the illustrated embodiment, the multi-process automatic machining system 100 further can include a second machining device 60, a detecting device 70, a transfer mechanism 80, and a qualified product collection device 90. The second machining device 60 can be positioned opposite to the second robot 22 and located at an end of the first machining devices 30 away from the tray transfer device 10. In at least one embodiment, the second machining device 60 and the first machining device 30 can be different devices to machine the workpiece in different processes. The second machining device 60 can be a marking device.

The detecting device 70 can be positioned at a side of the second robot 22 away from the fourth transfer table 54. The transfer mechanism 80 can be positioned at a side of the detecting device 70 away from the second robot 22. The transfer mechanism 80 can be portioned between the detecting device 70 and the third robot 23. The qualified product collection device 90 can be positioned at a side of the third robot 23 away from the detecting device 70. The third robot 23 can be positioned between the transfer mechanism 80 and the qualified product collection device 90. The detecting device 70 can be configured to detect a workpiece after being machined by the first machining devices 30 and the second machining device 60 and judge whether the workpiece is qualified. The transfer mechanism 80 can be configured to separately transfer defective workpieces and qualified workpieces. The third robot 23 can be configured to take the qualified workpieces from the transmission mechanism 80 to the qualified product collection device 90 and take the defective workpieces from the transmission mechanism 80 to a collection box 91 adjacent to the qualified product collection device 90. Thus, the qualified workpieces and the defective workpieces can be arranged apart.

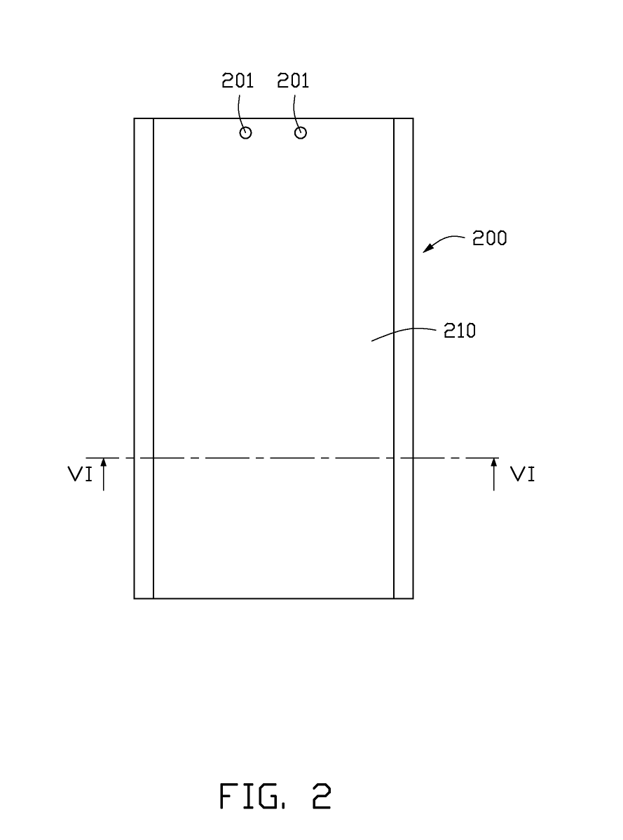

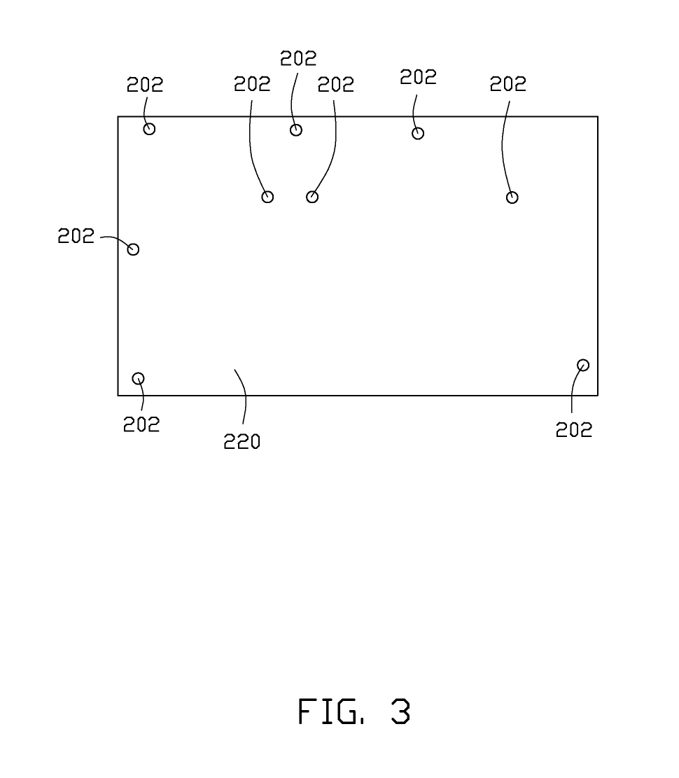

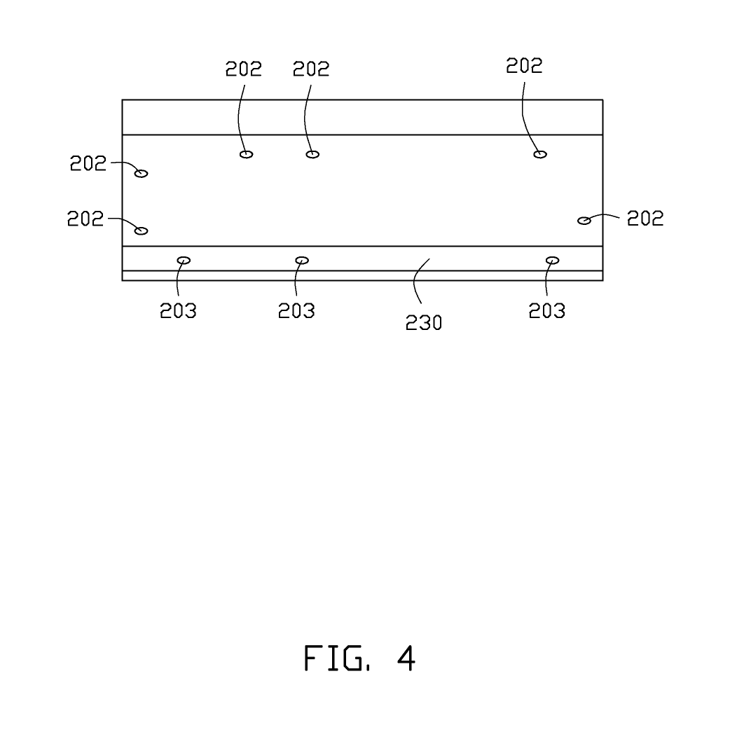

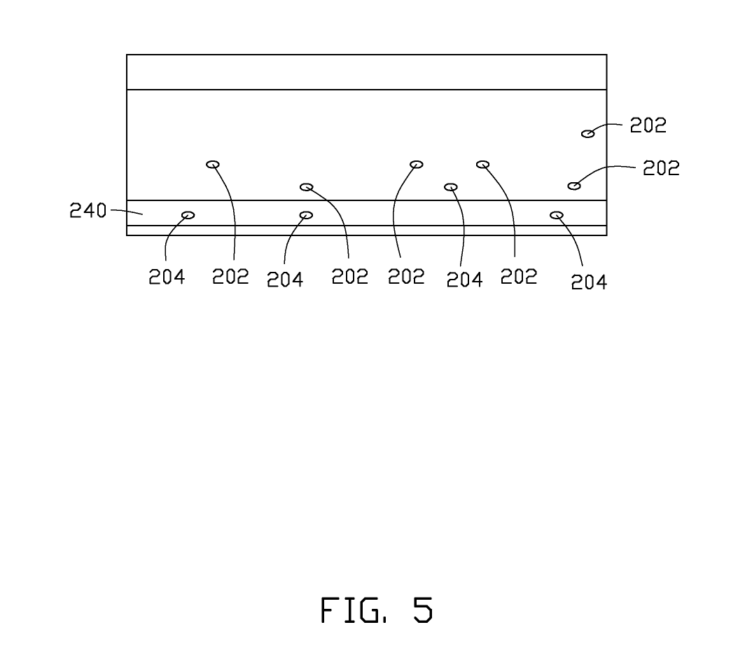

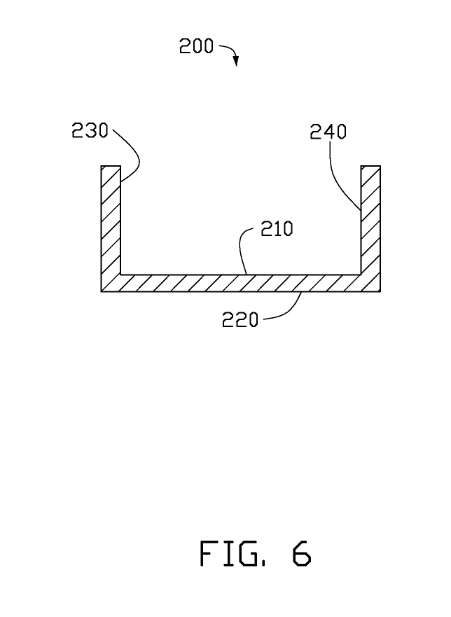

In illustrated embodiment, the multi-process automatic machining system 100 can be configured to rivet and mark a workpiece 200 (shown in FIG. 2). FIGS. 2-5 show the workpiece 200 in different angles. FIG. 6 shows the workpiece 200 in a cross-sectional view. The workpiece 200 can be a substantially U-shaped member. The workpiece 200 can include a first machining surface 210, a second machining surface 220, a third machining surface 230, and a fourth machining surface 240. The second machining surface 220 can be positioned opposite to the first machining surface 210 and parallel to the first machining surface 210. The third machining surface 230 can be substantially perpendicular to the first machining surface 210 and the second machining surface 220. The fourth machining surface 240 can be opposite to the third machining surface 230 and parallel to the third machining surface 230. The fourth machining surface 240 can be substantially perpendicular to the first machining surface 210 and the second machining surface 220.

When in use, first, the workpiece 200 can be placed in a top try on the tray transfer device 10. The first machining surface 210 can be positioned upwards.

Second, the first robot 21 adjacent to the tray transfer device 10 can grasp the workpiece 200 from the top tray and move the workpiece 200 to the adjacent first machining device 30. The first machining device 30 can machine the workpiece 200 hold by the first robot 21. In the illustrated embodiment, the first machining device 30 can rivet first machining positions 201 of the first machining surface 210.

Third, after the first machining positions 201 of the workpiece 200 being machined by the adjacent first machining device 30, the first robot 21 adjacent to the tray transfer device 10 can translationally move the workpiece 200 to the first transfer table 50. Due to the first robot 21 moves the workpiece 200 in translationally motion and does not rotate the workpiece 200, thus the first machining surface 210 of the workpiece 200 can still positioned upwards. The first transfer table 50 can rotate the workpiece 200 in 180 degrees, thus the second machining surface 220 can be positioned upwards. The next first robot 21 between the first transfer table 51 and the second transfer table 52 can grasp the workpiece 200 from the first transfer table 51 and translationally move the workpiece 200 to the next first machining device 30. The corresponding machining device 30 can machine the workpiece 200 hold by the first robot 21. In the illustrated embodiment, the first machining device 30 can rivet second machining positions 202 of the second machining surface 220.

Fourth, after the second machining positions 202 of the workpiece 200 being machined by the corresponding first machining device 30, the first robot 21 between the first transfer table 51 and the second transfer table 52 can translationally move the workpiece 200 to the second transfer table 52. Due to the first robot 21 between the first transfer table 51 and the second transfer table 52 moves the workpiece 200 in translationally motion and does not rotate the workpiece 200, thus the second machining surface 220 of the workpiece 200 still positioned upwards. The second transfer table 52 can rotate the workpiece 200 in an acute angle. In the illustrated embodiment, the acute angle is 70 degrees, thus the third machining surface 230 of the workpiece 200 can be positioned ramp upwards. The next first robot 21 between the second transfer table 52 and the third transfer table 53 can grasp the workpiece 200 from the second transfer table 52 and translationally move the workpiece 200 to the next first machining device 30. The corresponding first machining device 30 can machine the workpiece 200 hold by the first robot 21. In the illustrated embodiment, the first machining device 30 can rivet third machining positions 203 of the third machining surface 230.

Fifth, after the third machining positions 203 of the workpiece 200 being machined by the corresponding first machining device 30, the first robot 21 between the second transfer table 52 and the third transfer table 53 can translationally move the workpiece 200 to the third transfer table 53. Due to the first robot 21 between the second transfer table 52 and the third transfer table 53 moves the workpiece 200 in translationally motion and does not rotate the workpiece 200, thus the third machining surface 230 of the workpiece 200 can be still positioned ramp upwards. The third transfer table 53 can rotate the workpiece 200 in 180 degrees, thus the fourth machining surface 240 of the workpiece 200 can be positioned ramp upwards. The next first robot 21 between the third transfer table 53 and the fourth transfer table 54 can grasp the workpiece 200 from the third transfer table 52 and translationally move the workpiece 200 to the next first machining device 30. The corresponding first machining device 30 can machine the workpiece 200 hold by the first robot 21. In the illustrated embodiment, the first machining device 30 can rivet fourth machining positions 204 of the fourth machining surface 240.

Sixth, after the fourth machining positions 204 of the workpiece 200 being machined by the corresponding first machining device 30, the first robot 21 between the third transfer table 53 and the fourth transfer table 54 can translationally move the workpiece 200 to the fourth transfer table 54. Due to the first robot 21 between the third transfer table 53 and the fourth transfer table 54 moves the workpiece 200 in translationally motion and does not rotate the workpiece 200, thus the fourth machining surface 240 of the workpiece 200 can be still positioned ramp upwards. The fourth transfer table 54 can rotate the workpiece 200 in a proper degree to satisfy a next process of the second machining device 60. The second robot 22 can move the workpiece 20 from the fourth transfer table 54 to the second machining device 60. The second machining device 60 can machine the workpiece 200. In the illustrated embodiment, the second machining device 60 can mark the workpiece 200.

Seventh, the second robot 22 can grasp the workpiece 200 to the detecting device 70, the detecting device 70 can detect whether the previous processes are qualified. After the workpiece 200 being detected, the transfer mechanism 80 can depart the qualified workpiece and the defective workpiece, such as using a guiding mechanism (not shown). The third robot 23 can grasp the workpiece 200 from the transfer mechanism 80 to the qualified product collection device 90 or the collection box 91 according to a detecting result.

In at least one embodiment, the transfer table 50 can be not limited to rotate the workpiece 200 in above mentioned degrees. The transfer table can be designed to rotate the workpiece 200 in a proper degree according to different demands. The four first machining devices 30 can be different devices according to different demands.

The embodiments shown and described above are only examples. Many details are often found in the art such as the other features of a multi-process automatic machine system. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A multi-process automatic machine system configured to machine different surfaces of a workpiece, the workpiece comprising a first machining surface and a second machining surface, the multi-process automatic machine system comprising:
at least two first robots;
at least two first machining devices, each first machining device positioned adjacent to one of the at least two first robots, one of the at least two first machining devices configured to machine the first machining surface of the workpiece and another one of the at least two first machining devices configured to machine the second machining surface of the workpiece; and
at least one transfer table positioned between the at least two first robots;
wherein, one of the at least two first robots is configured to translationally move the workpiece to the at least one transfer table after the first machining surface being machined, the at least one transfer table is configured to rotate the workpiece, another one of the at least two first robots is configured to translationally move the workpiece from the at least one transfer table to the other one of the at least two first machining device.

2. The multi-process automatic machine system of claim 1, further comprising a detecting device positioned at a side of the at least two first robots and configured to detect the workpiece being machined by the at least two first machining devices.

3. The multi-process automatic machine system of claim 2, further comprising:
a second machining device positioned adjacent to one of the at least two first machining devices; and
a second robot adjacent to the second machining device;
wherein a number of the at least one transfer table is two, one of the transfer tables is positioned between the at least two first robots and another one of the transfer table is positioned between one of the at least two first robots and the second robot, each of the two transfer tables is configured to rotate the workpiece thereon, the second robot is configured to translationally move the workpiece from the adjacent one of the transfer tables to the second machining device and translationally move the workpiece being machined by the second machining device to the detecting device, the second machining device is configured to machine the workpiece hold by the second robot.

4. The multi-process automatic machine system of claim 3, further comprising a transfer mechanism positioned at a side of the detecting device away from the second robot and configured to transfer the workpiece being detected.

5. The multi-process automatic machine system of claim 4, further comprising:
a qualified product collection device; and
a third robot positioned between the transfer mechanism and the qualified product collection device, the third robot configured to move a qualified workpiece to the qualified product collection device.

6. The multi-process automatic machine system of claim 5, further comprising a collection box positioned adjacent to the qualified product collection device, wherein the third robot is configured to move a defective workpiece to the collection box.

7. The multi-process automatic machine system of claim 3, wherein each of the at least two first machining devices is a riveting device, the second machining device is a mark device.

8. The multi-process automatic machine system of claim 1, further comprising a tray transfer device positioned at an end of the at least two first robots and adjacent to one of the at least two first robots.

9. A multi-process automatic machine system configured to machine a workpiece having a first machining surface and a second machining surface, the multi-process automatic machine system comprising:
two first robots;
two first machining devices, each first machining device positioned adjacent to one of the first robots, one of the first machining devices configured to machine a first machining surface of the workpiece and another one of the first machining devices configured to machine a second machining surface of the workpiece opposite to the first machining surface; and
at least one transfer table positioned between the first robots;
wherein, one of the first robots is configured to translationally move the workpiece to the at least one transfer table after the first machining surface being machined, the at least one transfer table is configured to rotate the workpiece in degrees, another one of the first robots is configured to translationally move the workpiece from the at least one transfer table to the other one of the first machining device.

10. The multi-process automatic machine system of claim 9, further comprising a detecting device positioned at a side of the first robots and configured to detect the workpiece being machined by the first machining devices.

11. The multi-process automatic machine system of claim 10, further comprising:
a second machining device positioned adjacent to one of the first machining devices; and
a second robot adjacent to the second machining device;
wherein a number of the at least one transfer table is two, one of the transfer tables is positioned between the first robots and another one of the transfer table is positioned between one of the first robots and the second robot, one of the two transfer tables is configured to rotate the workpiece thereon in degrees and another of the transfer tables is configured to rotate the workpiece thereon in degrees, the second robot is configured to translationally move the workpiece from the adjacent one of the transfer tables to the second machining device and translationally move the workpiece being machined by the second machining device to the detecting device, the second machining device is configured to machine the workpiece hold by the second robot.

12. The multi-process automatic machine system of claim 11, further comprising a transfer mechanism positioned at a side of the detecting device away from the second robot and configured to transfer the workpiece being detected.

13. The multi-process automatic machine system of claim 12, further comprising:
a qualified product collection device; and
a third robot positioned between the transfer mechanism and the qualified product collection device, the third robot configured to move a qualified workpiece from the transfer mechanism to the qualified product collection device.

14. The multi-process automatic machine system of claim 13, further comprising a collection box positioned adjacent to the qualified product collection device, wherein the third robot is configured to move a defective workpiece from the transfer mechanism to the collection box.

15. The multi-process automatic machine system of claim 11, wherein each of the first machining devices is a riveting device, the second machining device is a mark device.

16. The multi-process automatic machine system of claim 9, further comprising a tray transfer device positioned at an end of the first robots and adjacent to one of the first robots.
